(19) United States
(12) Patent Application Publication
(10) Pub. No.: US 2014/0267995 A1
(43) Pub. Date: Sep. 18, 2014

(54) PIXEL STRUCTURE

(71) Applicant: E Ink Holdings Inc., Hsinchu (TW)

(72) Inventors: Kuan-Yi Lin, Hsinchu (TW); Fang-An Shu, Hsinchu (TW); Tzung-Wei Yu, Hsinchu (TW)

(73) Assignee: E Ink Holdings Inc., Hsinchu (TW)

(21) Appl. No.: 14/100,031

(22) Filed: Dec. 9, 2013

(30) Foreign Application Priority Data
Mar. 15, 2013 (TW) 102109292

(51) Int. Cl. G02F 1/1343

(52) U.S. Cl. CPC G02F 1/134309
USPC 349/141

(57) ABSTRACT

A pixel structure disposed on a substrate is provided. The pixel structure includes an active device, a first electrode, a second electrode and an alignment layer. The active device is disposed on the substrate. The first electrode is disposed on the substrate and has a plurality of slits. A thickness of the first electrode is from 20 Å to 100 Å. The second electrode is disposed on the substrate and electrically independent from the first electrode. A portion of the area of the second electrode is located inside the first slits. One of the first electrode and the second electrode is electrically connected to the active device. The alignment layer covers at least the first electrode and the first slits.

### CROSS-REFERENCE TO RELATED APPLICATION

This application claims the priority benefit of Taiwan application serial no. 102109292, filed on Mar. 15, 2013. The entirety of the above-mentioned patent application is hereby incorporated by reference herein and made a part of this specification.

### TECHNICAL FIELD

The invention is related to a pixel structure, and more particularly, to a pixel structure having a plurality of slits on an electrode.

### BACKGROUND

Flat-panel displays currently common in the market realize display of images primarily by driving a display medium with a pixel array substrate, wherein a plurality of pixel structures arranged in arrays are disposed on the pixel array substrate. Generally, each pixel structure is mostly formed by an active device and a pixel electrode connected to the active device, wherein pattern designs of the pixel electrode may influence the distribution of the electric field provided by the pixel structure for application in different display panels. For instance, an In-Plane Switching (IPS) liquid crystal display panel and a Fringe Field Switching (FFS) liquid crystal display panel both realize the needed driving electric field by disposing a plurality of slits on the pixel electrode.

However, since the pixel electrodes have a certain thickness, the pixel electrodes having the plurality of slits also cause the pixel structures with uneven surface. At this point, an alignment layer disposed on the pixel electrodes for guiding a specific arrangement of liquid crystal molecules in the liquid crystal layer fluctuates along with the slits on the pixel electrodes. Thereby, when a rubbing alignment treatment is performed on the alignment layer, non-uniform alignment happens, which is unfavorable to the quality of the liquid crystal display panel.

### SUMMARY

A pixel structure having a desirable surface flatness is provided.

A pixel structure of the invention is disposed on a substrate. The pixel structure includes an active device, a first electrode, a second electrode and an alignment layer. The active device is disposed on the substrate. The first electrode is disposed on the substrate and has a plurality of slits, wherein a thickness of the first electrode is from 20 Å to 100 Å. The second electrode is disposed on the substrate and electrically independent from the first electrode, and at least a portion of the area of the second electrode is located inside the first slits. One of the first electrode and the second electrode is electrically connected to the active device. The alignment layer covers at least the first electrode and the first slits.

In an embodiment of the invention, the second electrode is located between the first electrode and the substrate. At this point, the pixel structure further includes an insulating layer disposed between the first electrode and the second electrode.

In an embodiment of the invention, the second electrode and the first electrode share a same plane, and the second electrode has a plurality of second slits, so that the first electrode is at least partially located in the second slits. At this point, the alignment layer also covers the second electrode and the second slits. A thickness of the second electrode may be from 20 Å to 100 Å, and a light transmittance of the second electrode may be from 60% to 100%.

In an embodiment of the invention, the other of the first electrode and the second electrode is connected to a common potential.

In an embodiment of the invention, the first electrode is electrically connected to the active device. Besides, the pixel structure may further include a connecting electrode, and the connecting electrode is connected between the active device and the first electrode. A thickness of the connecting electrode is, for example, larger than the thickness of the first electrode.

In an embodiment of the invention, a material of the first electrode includes metal, metal oxide or a combination thereof.

In an embodiment of the invention, a light transmittance of the first electrode is from 60% to 100%.

Based on the above, the electrodes in the embodiments of the invention respectively have a plurality of slits and a thin thickness. Therefore, the electrodes do not create obvious unevenness on the pixel structures. At this point, the alignment layer covering the electrodes has desirable alignment uniformity and contributes to enhancing the quality of the pixel structures.

To make the above features and advantages of the invention more comprehensible, several embodiments accompanied by drawings are described in detail as follows.

### BRIEF DESCRIPTION OF THE DRAWINGS

FIG. 1 is a schematic top view of a pixel structure according to a first embodiment of the invention.

FIG. 2 is a schematic cross-sectional view of the pixel structure of FIG. 1 along a cross-section line I-I′.

FIG. 3 is a schematic cross-sectional view of a pixel structure according to a second embodiment of the invention.

FIG. 4 is a schematic cross-sectional view of a pixel structure according to a third embodiment of the invention.

FIG. 5 is a schematic top view of a pixel structure according to a fourth embodiment of the invention.

FIG. 6 is a schematic cross-sectional view of the pixel structure of FIG. 5 along a cross-section line II-II′.

FIG. 7 is a schematic cross-sectional view of a pixel structure according to a fifth embodiment of the invention.

### DETAILED DESCRIPTION OF DISCLOSED EMBODIMENTS

FIG. 1 is a schematic top view of a pixel structure according to a first embodiment of the invention, and FIG. 2 is a schematic cross-sectional view of the pixel structure of FIG. 1 along a cross-section line I-I′. Referring to FIGS. 1 and 2, a pixel structure 100 is disposed on a substrate 10, and the pixel structure 100 includes an active device 110, a first electrode 120, a second electrode 130, an alignment layer 140, an insulating layer 150 and another insulating layer 160.

The active device 110 is, for example, a thin film transistor, and includes a gate 112, a channel layer 114, a source 116 and a drain 118. Herein, the active device 110 has a bottom-gate thin film transistor structure, but the invention is not limited thereto. In other embodiments, the active device 110 may have a top-gate thin film transistor structure. In addition, a material of the channel layer 114 may be selectively an amorphous-silicon semiconductor material, a polysilicon semiconductor material, an organic semiconductor material, an oxide semiconductor material or other semiconductor materials. Materials of the gate 112, the source 116 and the drain 118 may be metal, metal oxide or other semiconductor materials.

In the present embodiment, the first electrode 120 and the second electrode 130 are stacked with each other. The first electrode 120 has a plurality of slits 122, and the slits 122 expose part of the area of the second electrode 130 and thus form a Fringe Field Switching (FFS) structural design. That is to say, at least a part of the area of the second electrode 130 is located in the slits 122. Besides, the first electrode 120 and the second electrode 130 are electrically independent from each other. The first electrode 120 is, for example, connected to a drain 118 of the active device 110, and the second electrode 130 is, for example, connected to a common potential. Therefore, when the pixel structure 100 is driven, the first electrode 120 and the second electrode 130 located in the slits 122 may have different potentials and thus form a driving electric field. Nevertheless, the invention is not limited thereto. In other embodiments, the first electrode 120 may be selectively connected to the common potential, and the second electrode 130 is thus connected to the active device 110, so as to form the needed driving electric field.

In the present embodiment, a material of the first electrode 120 is metal or metal oxide, and a thickness T1 of the first electrode 120 is from 20 Å to 100 Å. Therefore, the first electrode 120 may have a good light transmittance. For instance, the light transmittance of the first electrode 120 may be from 60% to 100%. Meanwhile, the second electrode 130 may be fabricated with a transparent conductive material and thus contribute to enhancing the light transmittance of the pixel structure 100, but the invention is not limited thereto. In other embodiments, the second electrode 130 may selectively be fabricated together with the gate 112. Therefore, the material of the second electrode 130 may be identical with that of the gate 112 or be a conductive material different than that of the gate 112.

The alignment layer 140 covers the first electrode 120 and the slits 122. To offer an alignment capability, the alignment layer 140 is, for example, aligned by rubbing or similar processing treatments. Take rubbing alignment treatment for example, the surface of the alignment layer 140 is rubbed by bristles F to form a needed alignment structure. Generally speaking, the flatter the surface where the alignment layer 140 is disposed, the more uniformly the rubbing operation of the bristles F is performed on the alignment layer 140, so as to achieve a desirable alignment effect. Therefore, in the present embodiment, the thickness T1 of the first electrode 120 is from 20 Å to 100 Å. Thus, although the first electrode 120 of the present embodiment has a plurality of slits 122, a height difference between the locations of the first electrode 120 and the slits 122 is not obvious, which contributes to forming a uniform alignment structure in the alignment layer 140.

More particularly, when the bristles F rub the alignment layer 140 along a direction D, the rubbing actions performed on the alignment layer 140 located in positions A and B is affected by the height difference between the locations of the first electrode 120 and the slits 122. The thicker the thickness T1 of the first electrode 120, the larger the difference between the rubbing operations received by the alignment layer 140 located in positions A and B, which means that the alignment uniformity is worse. On the contrary, the thinner the thickness T1 of the first electrode 120, the smaller the difference between the rubbing operations received by the alignment layer 140 located in positions A and B, which means that the alignment uniformity is better. Therefore, a design for thinning the thickness T1 of the first electrode 120 from 20 Å to 100 Å in the present embodiment contributes to a desirable quality of the pixel structure 100. Especially when the pixel structure 100 is applied to a liquid crystal display panel, a uniform and consistent alignment can be provided to the liquid crystal layer in the liquid crystal display panel, so as to enhance the display quality of the liquid crystal display panel.

In the present embodiment, to realize the electrical properties of each member, the pixel structure 100 further includes the insulating layers 150 and 160. The insulating layer 150 is disposed between the gate 112 and the channel layer 114. The insulating layer 160 covers the active device 110, so that the active device 110 is located between the insulating layer 160 and the substrate 10. Meanwhile, the insulating layer 160 has a contact window 162, so that the first electrode 120 extends into the contact window 162 to be connected to the drain 118 of the active device 110. Besides, FIG. 2 shows that the second electrode 130 is located between the insulating layer 150 and the substrate 10, but the invention is not limited thereto. In other embodiments, the second electrode 130 may be selectively located between the insulating layers 150 and 160.

FIG. 3 is a schematic cross-sectional view of a pixel structure according to a second embodiment of the invention. Referring to FIG. 3, a pixel structure 200 is substantially similar to the pixel structure 100 and includes an active device 110, a first electrode 120, a second electrode 130, an alignment layer 140, an insulating layer 150, an insulating layer 160 and a connecting electrode 210. That is to say, the pixel structure 200 differs from the pixel structure 100 primarily in further including the connecting electrode 210. The connecting electrode 210 is connected to the drain 118 of the active device 110 and the first electrode 120, and a thickness T2 of the connecting electrode 210 is larger than the thickness T1 of the first electrode 120. At this point, compared with the first electrode 120, the connecting electrode 210 does not easily break off at the contact window 162. Therefore, the arrangement of the connecting electrode 210 contributes to ensuring the electrical connection between the first electrode 120 and the active device 110. In other words, in the present embodiment, the first electrode 120 may be connected to the drain 118 of the active device 110 through the connecting electrode 210. Nonetheless, the invention does not have a limitation for a stacking sequence of the connecting electrode 210 and the first electrode 120. In other embodiments, the connecting electrode 210 may be disposed above the first electrode 120, so that the first electrode 120 is located between the connecting electrode 210 and the drain 118. At this point, the connecting electrode 210 also contributes to ensuring the electrical connection between the first electrode 120 and the active device 110.

FIG. 4 is a schematic cross-sectional view of a pixel structure according to a third embodiment of the invention. Referring to FIG. 4, a pixel structure 300, similar to the pixel structure 100, includes an active device 110, a first electrode 310, a second electrode 320, an alignment layer 140, an insulating layer 150 and an insulating layer 160. Herein, descriptions relevant to the active device 110, the alignment layer 140, the insulating layer 150 and the insulating layer 160 may be referred in the first embodiment without repetition here. Therefore, further descriptions are provided for the first electrode 310 and the second electrode 320.

In the present embodiment, the second electrode 320 is placed between the first electrode 310 and the substrate 10, and is located between the insulating layer 150 and the insulating layer 160. The second electrode 320 is connected to the drain 118 of the active device 110. The first electrode 310 is connected to a common potential. In addition, the first electrode 310 has a plurality of slits 312, so that part of the area of the second electrode 320 is located in the slits 312 to realize the driving of the pixel structure 300.

A thickness T1 of the first electrode 310 of the present embodiment is from 20 Å to 100 Å. Therefore, even if the first electrode 310 has the slits 312, a surface structure having obvious fluctuation is not created. Therefore, the alignment layer 140 receives alignment treatment uniformly and thus has a uniform alignment function. In other words, similar to the above embodiments, the pixel structure 300 has a desirable quality, and especially contributes to enhancing the display quality of the liquid crystal display panel.

In the aforementioned plurality of embodiments, two electrodes are stacked with each other and separated by at least one insulating layer, but the invention is not limited thereto. FIG. 5 is a schematic top view of a pixel structure according to a fourth embodiment of the invention, and FIG. 6 is a schematic cross-sectional view of the pixel structure of FIG. 5 along a profile I-I′. Referring to FIGS. 5 and 6, a pixel structure 400 is disposed on a substrate 10, and the pixel structure 400 includes an active device 110, a first electrode 410, a second electrode 420, an alignment layer 140, an insulating layer 150 and an insulating layer 160. Herein, the active device 110, the alignment layer 140, the insulating layer 150 and the insulating layer 160 may be referred in the descriptions in the aforementioned embodiments without further repetition.

In the present embodiment, the first electrode 410 and the second electrode 420 are both placed on the insulating layer 160. That is to say, the first electrode 410 and the second electrode 420 are disposed on the same plane to form a In-Plane Switching (IPS) structural design. Besides, the first electrode 410 and the second electrode 420 are respectively comb electrodes and are arranged alternatively. The first electrode 410 is electrically connected to a drain 118 of the active device 110 through a contact window 162 in the insulating layer 160, and the second electrode 420 is connected to a common potential. Thus, when the pixel structure 400 is driven, the first electrode 410 and the second electrode 420 have different potentials to form a needed driving electric field.

The first electrode 410 has a plurality of first slits 412, and the second electrode 410 has a plurality of second slits 422, wherein at least part of the area of the first electrode 410 is located in the second slits 422, and at least part of the area of the second electrode 420 is located in the first slits 412. Furthermore, to avoid electrical connection between the first electrode 410 and the second electrode 420, a spacing 430 is disposed between the first electrode 410 and the second electrode 420. In the present embodiment, the spacing 430 is substantially the overlapping region of the first slits 412 and the second slits 422.

In addition, in the present embodiment, the first electrode 410 and the second electrode 420 may substantially be made from a same material layer, and a material of the material layer may be metal, metal oxide or a combination thereof. Furthermore, a thickness T3 of the first electrode 410 and a thickness T4 of the second electrode 420 are both from 20 Å to 100 Å. Therefore, the first electrode 410 and the second electrode 420 both have good light transmittances, such as from 60% to 100%. In addition, since the first electrode 410 and the second electrode 420 have thinning designs, the height difference between the first electrode 410, the second electrode 420 and the spacing 430 is not obvious. Therefore, the alignment layer 140 covering the first electrode 410 and the second electrode 420 may be rubbed uniformly in a rubbing alignment treatment, and thus contributes to enhancing the quality of the pixel structure 400.

FIG. 7 is a schematic cross-sectional view of a pixel structure according to a fifth embodiment of the invention. Referring to FIG. 7, a pixel structure 500 is substantially similar to the pixel structure 400 and includes an active device 110, a first electrode 410, a second electrode 420, an alignment layer 140, an insulating layer 150, an insulating layer 160 and a connecting electrode 510. That is to say, the pixel structure 500 differs from the pixel structure 400 primarily in further including the connecting electrode 510. The connecting electrode 510 is connected between a drain 118 of the active device 110 and the first electrode 410, and a thickness T5 of the connecting electrode 510 is larger than the thickness T3 of the first electrode 410 and the thickness T4 of the second electrode 420. At this point, compared with the first electrode 100, the connecting electrode 510 does not easily break off at a contact window 162, and therefore the disposition of the connecting electrode 510 contributes to ensuring the electrical connection between the first electrode 410 and the active device 110. Herein, although the connecting electrode 510 is shown to be located between the first electrode 410 and the drain 118, the invention is not limited thereto. In other embodiments, the first electrode 410 may be located between the connecting electrode 510 and the drain 118.

In light of the above, the pixel structures in the embodiments of the present invention adopt electrodes having slits and thinned thicknesses. The height difference between the location of the electrodes and the slits is not obvious, and therefore the process of rubbing treatment on the alignment layer of the electrodes may be performed more uniformly. Thus, the pixel structures in the embodiments of the present invention have desirable qualities.

What is claimed is:

1. A pixel structure disposed on a substrate, the pixel structure comprising:
an active device disposed on the substrate;
a first electrode disposed on the substrate and having a plurality of first slits, wherein a thickness of the first electrode is from 20 Å to 100 Å;
a second electrode disposed on the substrate and electrically independent from the first electrode, an area of the second electrode being at least partially located in the plurality of first slits, wherein one of the first electrode and the second electrode is electrically connected to the active device; and
an alignment layer at least covering the first electrode and the first slits.

2. The pixel structure as claimed in claim 1, wherein the second electrode is located between the first electrode and the substrate.

3. The pixel structure as claimed in claim 2, further comprising an insulating layer disposed between the first electrode and the second electrode.

4. The pixel structure as claimed in claim 1, wherein the second electrode and the first electrode share a same plane, and the second electrode has a plurality of second slits, so that the first electrode is at least partially located in the plurality of second slits.

5. The pixel structure as claimed in claim 4, wherein a thickness of the second electrode is from 20 Å to 100 Å.

6. The pixel structure as claimed in claim 4, wherein the alignment layer further covers the second electrode and the second slits.

7. The pixel structure as claimed in claim 4, wherein a light transmittance of the second electrode is from 60% to 100%.

8. The pixel structure as claimed in claim 1, wherein the other of the first electrode and the second electrode is connected to a common potential.

9. The pixel structure as claimed in claim 1, wherein the first electrode is electrically connected to the active device.

10. The pixel structure as claimed in claim 9, further comprising a connecting electrode, the connecting electrode being connected between the active device and the first electrode.

11. The pixel structure as claimed in claim 10, wherein a thickness of the connecting electrode is greater than the thickness of the first electrode.

12. The pixel structure as claimed in claim 1, wherein a material of the first electrode comprises metal, metal oxide or a combination thereof.

13. The pixel structure as claimed in claim 1, wherein a light transmittance of the first electrode is from 60% to 100%.
